(19) United States
(12) Patent Application Publication
(10) Pub. No.: US 2003/0213237 A1
(43) Pub. Date: Nov. 20, 2003

(54) Torque fluctuation absorber

(75) Inventors: Masaru Ebata, Chita-shi (JP); Makoto Takeuchi, Kariya-shi (JP)

Correspondence Address: BURNS, DOANE, SWECKER & MATHIS, L.L.P., P.O. Box 1404, Alexandria, VA, 22313-1404, US

(73) Assignee: AISIN SEIKI KABUSHIKI KAISHA, Kariya-shi (JP)

(21) Appl. No.: 10/396,511

(22) Filed: Mar. 26, 2003

(30) Foreign Application Priority Data
Mar. 26, 2002 (JP) 2002-085954

(51) Int. Cl. F16D 33/00

(52) U.S. Cl. 60/338

(57) ABSTRACT

A torque fluctuation absorber for a hybrid vehicle includes a first rotational member connected with an internal combustion engine, a second rotational member connected with a generator, a first torsion member located between the first rotational member and the second rotational member, and having a torsional rigidity established to absorb an operation-related fluctuation torque of the generator, and a second torsion member located between the first rotational member and the second rotational member, and having a torsional rigidity greater than that of the first torsion member.

This application is based on and claims priority under 35 U.S.C. § 119 with respect to Japanese Application No. 2002-085954 filed on Mar. 26, 2002, the entire content of which is incorporated herein by reference.

### FIELD OF THE INVENTION

The present invention generally relates to a torque fluctuation absorber. More particularly, the present invention pertains to a torque fluctuation absorber for absorbing torque fluctuations in a hybrid vehicle having both an internal combustion engine and an electrical motor, as well as a generator.

### BACKGROUND OF THE INVENTION

An example of a known torque fluctuation absorber is disclosed in Japanese Patent Laid-Open Publication No. 2002-13547. This known torque fluctuation absorber, used for a hybrid vehicle, includes a first rotational member rotated by an internal combustion engine, a second rotational member connected with an electric motor, torsion members which control torque differences between the first rotational member and the second rotational member, and a limit mechanism. The limit mechanism cuts off the rotational transmission from the first rotational member to the second rotational member when the volume or amount of torque difference therebetween is greater than a predetermined level. The torsion members include two types of torsion springs, both of which are mounted in the torque fluctuation absorber. Japanese Patent Laid-Open Publication No. 2002-13547 does not include any information regarding the torsional rigidities of the torsion springs.

The hybrid vehicle typically has a generator which is located between the torque fluctuation absorber and the electric motor so that the internal combustion engine generates electricity. However, when the internal combustion engine generates electricity during an idling condition of the vehicle especially, there is a possibility that unabsorbed torque fluctuation is transmitted to the generator. Thus, the generation of electricity may be unstable because the transmitted torque to the generator is not constant.

Another potential problem resides in the speed reducing gear train. Normally, hybrid vehicles have a speed reducing gear train, such as a planetary gear drive, between the torque fluctuation absorber and the electrical motor. However, when torque fluctuations are transmitted to the speed reducing gear train without being reduced, the speed reducing gear train can exhibit shaking noise.

### SUMMARY OF THE INVENTION

According to one aspect, a torque fluctuation absorber for a hybrid vehicle includes a first rotational member which is connected with an internal combustion engine, a second rotational member which is connected with a generator, a first torsion, which is located between the first rotational member and the second rotational member, and whose torsional rigidity is established so as to absorb an operation-related fluctuation torque of the generator, and a second torsion, which is located between the first rotational member and the second rotational member, and whose torsional rigidity is larger than that of the first torsion.

In accordance with another aspect, a torque fluctuation absorber for a hybrid vehicle includes a first rotational member connected with an internal combustion engine, a second rotational member connected with a generator, a first torsion member located between the first rotational member and the second rotational member, a second torsion member located between the first rotational member and the second rotational member, and a third torsion member located between the first rotational member and the second rotational member. The first torsion member has a torsional rigidity adapted to absorb an operation-related fluctuation torque of the generator at a minimum necessary rotational torque for operating the generator during contraction of the first torsion member, while the second torsion member has a torsional rigidity adapted to absorb an operation-related fluctuation torque of the generator at a maximum necessary rotational torque for operating the generator during contraction of the second torsion member. In addition, the third torsion member has a torsional rigidity larger than that of the second torsion member during contraction of the third torsion member.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a schematic block diagram of a hybrid system for a hybrid vehicle, including a torque fluctuation absorber in accordance with the present invention.

FIG. 2 is an elevational view of the torque fluctuation absorber according to a first embodiment, with some of the parts being broken away for purposes of clarity and ease in understanding.

FIG. 3 is a cross-sectional view of the torque fluctuation absorber taken along the section line A-A in FIG. 2.

FIG. 4 is a graph illustrating torsional angle versus rotational torque in connection with operation of the first embodiment of the torque fluctuation absorber.

FIG. 5 is an elevational view of the torque fluctuation absorber according to a second embodiment, with some of the parts being broken away for purposes of clarity and ease in understanding.

FIG. 6 is a graph illustrating torsional angle versus rotational torque in connection with operation of the second embodiment of the torque fluctuation absorber.

### DETAILED DESCRIPTION

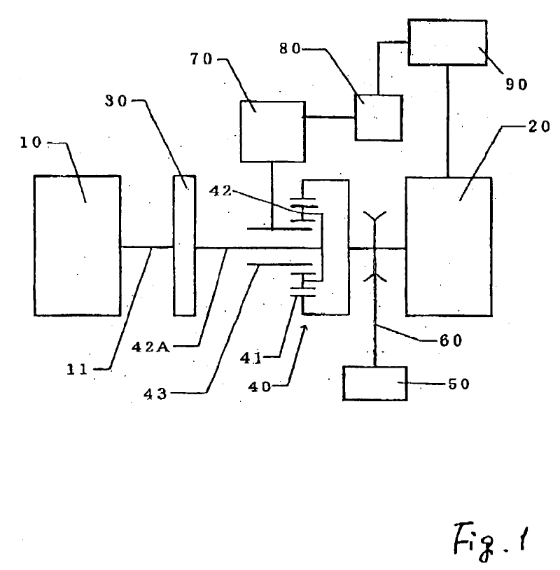

Referring to the schematic illustration in FIG. 1 depicting a hybrid system for a hybrid vehicle, the hybrid vehicle has an internal combustion engine 10, an electric motor 20, a torque fluctuation absorber 30, a planetary gear drive 40, a transmission 50, a generator 70 and a battery 90. The torque fluctuation absorber 30 is disposed between the internal combustion engine 10 and the electric motor 20. The torque fluctuation absorber 30 absorbs fluctuational torque (i.e., torque fluctuations) of the output torque from the internal combustion engine 10. The transmission 50 transmits rotational torque to the driven wheels.

The planetary gear drive 40 includes a ring gear 41. A belt 60 provides connection between the ring gear 41 and the transmission 50. The generator 70 is connected with the planetary gear drive 40. The battery 90 is electrically connected with the generator 70 via an inverter 80 and is also electrically connected to the electrical motor 20.

The output of the internal combustion engine 10 is connected with or transmitted to a carrier 42 of the planetary gear drive 40 via the torque fluctuation absorber 30. The generator 70 is connected with a sun gear 43 and converts the output torque of the internal combustion engine 10 to electric energy so that the battery 90 is charged by the electric energy. Here, the output torque of the electric motor 20 is connected with the ring gear 41 of the planetary gear drive 40.

Generally explaining the operation of the above hybrid system, when only the internal combustion engine 10 is operating, the output torque of the internal combustion engine 10 is transmitted to the carrier 42 of the planetary gear drive 40 via the torque fluctuation absorber 30 so that the carrier 42 rotates around an output shaft 11 of the internal combustion engine 10. The rotation of the carrier 42 causes the sun gear 43 to also rotate so that the generator 70 is operated or the rotation of the carrier 42 causes the ring gear 41 to rotate so as to transmit the rotational torque to the transmission 50 via the belt 60. On the other hand, when only the electric motor 20 is operating, the ring gear 41 is rotated so as to transmit the rotational torque to the transmission 50 via the belt 60. At that time, because the carrier 42 merely rotates and does not change position, the rotational torque of the electric motor 20 is not transmitted to the internal combustion engine 10. Further, it is also possible that both the internal combustion engine 10 and the electric motor 20 rotate together to transmit the rotational torques to the transmission 50. The changeover mechanism of the power source thereof is controlled by a controller according to signals such as the vehicle speed, pedal stroke of an accelerator, etc.

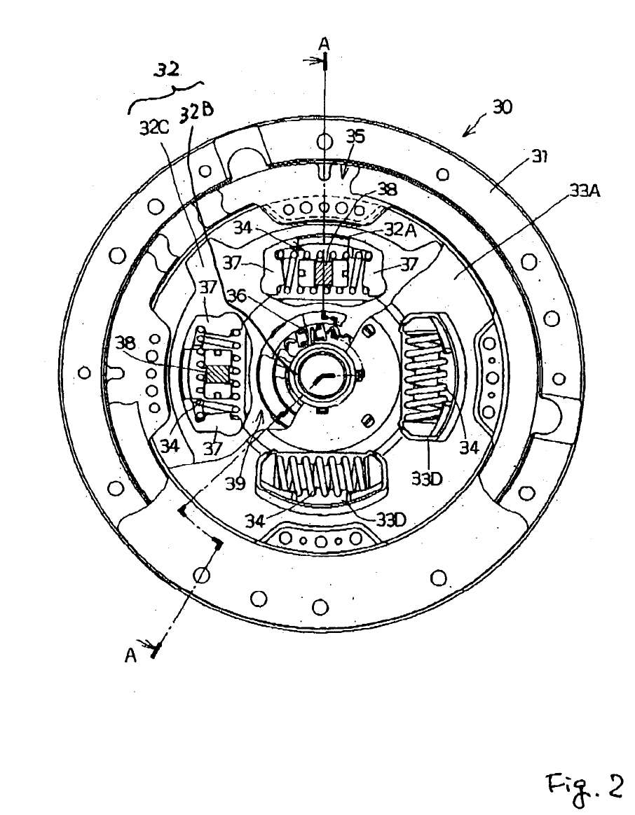

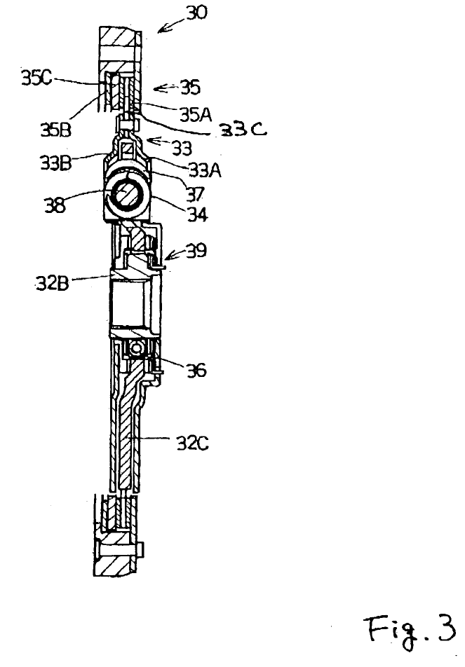

The details associated with the torque fluctuation absorber 30 will now be explained. As shown in FIGS. 2 and 3, the torque fluctuation absorber 30 is comprised of a first rotational member 31, a second rotational member 32, an intermediate member 33, four torsion members 34, pair of spring sheets 37, a limiter 35, and four rubber dampers 38. The first rotational member 31 is connected with the output shaft 11 of the internal combustion engine 10 so that the first rotational member 31 rotates with the output shaft 11 (shown in FIG. 1). The second rotational member 32 is connected with the electric motor 20 via a carrier axis 42A and the planetary gear drive 40 (both shown in FIG. 1). The second rotational member 32 is located along the same axis as the first rotational member 31. As shown in FIG. 1, the carrier axis 42A is connected with the carrier 42.

The intermediate member 33 is adapted to rotate within a predetermined angle against both the first rotational member 31 and the second rotational member 32. Each torsion members 34 is located within a respective hole 32A provided in the second rotational member 32, and is also located within a respective hole 33D provided in the intermediate member 33. The holes 32A of the second rotational member 32 are formed in a flange portion 32C of the second rotational member 32. The torsion members 34 control the torque fluctuation between the first rotational member 31 and the second rotational member 32, when the torsion members 34 are pressed.

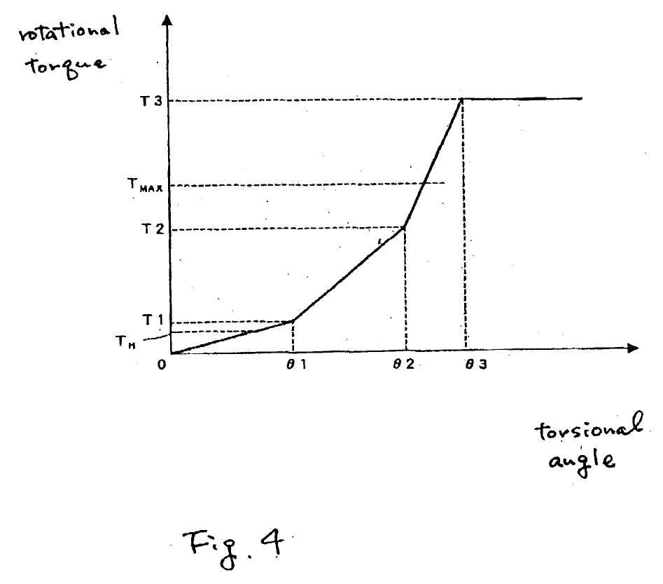

The pair of spring sheets is also located within the holes 32A and 33D to support the torsion member 34. Each of the rubber dampers 38 is inserted into or positioned in one of the torsion members 34. The length of the rubber damper 38 is shorter than that of the respective torsion member 34. The limiter 35 cuts or limits the torque transmission from the first rotational member 31 to the second rotational member 32 when the rotational torque transmitted from the first rotational member 31 toward the second rotational member 32 is larger than a predetermined level T3 as shown in FIG. 4.

The second rotational member 32 is comprised of a hub portion 32B and the flange portion 32C. Each of the hub portions 32B and the flange portions 32C is individually formed. The flange portion 32C is arranged around the hub portion 32B with a clearance so as to rotate each other. A torsion member 36 is located between the hub portion 32B and the flange portion 32C. The torsion member 36 absorbs torque fluctuation between the hub portion 32B and the flange portion 32C. The torsional rigidity of the torsion member 36 is smaller than that of the torsion members 34.

The intermediate member 33 is comprised of a first intermediate plate 33A, a second intermediate plate 33B and a plate 33C. The intermediate plates 33A, 33B, and the plate 33C are fixed by way of fastener which, in the illustrated embodiment, is in the form of a rivet. A hysteresis mechanism 39 is provided at the inner circumferential end of the first intermediate plate 33A. The hysteresis mechanism 39 produces a hysteresis with the second rotational member 32.

As shown in FIG. 2, the four torsion members 34, each of which is positioned within the holes 32A, 33D, are similarly constructed as torsion springs. The limiter 35 is located between the first rotational member 31 and the intermediate member 33. The limiter 35 is comprised of a frictional materials 35A, a plate spring 35B and a plate 35C. The frictional materials 35A are attached on both surfaces of the plate 33c of the intermediate member 33. The plate spring 35B presses one of the frictional materials 35A toward the other frictional material 35A.

The plate 35C can integrally rotate with the first rotational member 31, and can slide in the axis direction thereof. The hub portion 32B of the second rotational member 32 connects with a shaft, which connects with the carrier 42, by way of a spline combination. Thus, when the frictional materials 35A are worn away, the second rotational member 32 slides in the axis direction of the shaft to compensate for the abrasion.

The operation of the above described the torque fluctuation absorber 30 is as follows. The graph shown in FIG. 4 illustrates the torsional characteristics of the torque fluctuation absorber 30, with the vertical axis representing the rotational torque from the internal combustion engine 10 to the torque fluctuation absorber 30, and the horizontal axis representing the torsional angle between the first rotational member 31 and the second rotational member 32. When the rotational torque is between 0 and T1, the transmitted torque is transmitted to the intermediate member 33 via the limiter 35 so that the intermediate member 33 rotates. Then, the rotational torque of the intermediate member 33 is transmitted to the flange portion 32C of the second rotational member 32 via the torsion member 34. At this time, because the transmitted torque is comparatively small, the torsion member 34 transmits the rotational torque without contracting or being compressed. Further, the rotational torque is transmitted to the hub portion 32B while contracting the torsion member 36. When the rotational torque reaches T1 (when the torsional angle becomes θ1), the gap in the circumferential direction between the hub portion 32B and the flange portion 32C is filled up so that the torsion member 36 cannot contract any more.

In the above described embodiment, the torsional rigidity of the torsion member 36 is established such that the transmitted torque T1 is larger than a rotational torque T_{H}. The internal combustion engine 10 needs the level of the rotational torque T_{H} when the internal combustion engine 10 operates the generator 70. Therefore, when the generator 70 is operated, the torsion member 36 absorbs the torque fluctuation of the internal combustion engine 10.

When the rotational torque of the internal combustion engine 10 is between T1 and T2, the rotational torque is transmitted to the hub portion 32B while the torsion member 34 is contracted. At that time, the torsion member 36 is at the maximum contraction. Because the torsional rigidity of the torsion member 34 is stronger than that of the torsion member 36, the ratio of the rotational torque to the torsional angle in this condition, when the rotational torque is between T1 and T2, is larger than that of the above condition when the rotational torque is between 0 and T1. When the rotational torque becomes T2 (when the torsional angle becomes θ2), the torsion member 34 becomes shortened so that both of the spring sheets 37 contact the end of the rubber damper 38.

When the rotational torque of the internal combustion engine 10 is between T2 and T3, the rotational torque is transmitted to the hub portion 32B as both the torsion member 34 and the rubber damper 38 are further contracted. Since the torsional rigidity of the rubber damper 38 is stronger than that of the torsion member 34, the ratio of the rotational torque to the torsional angle in this condition, when the rotational torque is between T2 and T3, is larger than that of the above condition when the rotational torque is between T1 and T2.

When the rotational torque reaches T3 (when the torsional angle becomes θ3), the frictional material 35A of the limiter 35 starts to glide. Thus, the limiter 35 transmits the rotational torque no more than the rotational torque T3 from the intermediate member 33 to the second rotational member 32. Here, because the rotational torque T3 is larger than a rotational torque T_{MAX}, which is the maximum output torque of the internal combustion engine 10, it is not likely to happen that the frictional material 35A glides during operation of the torque fluctuation absorber 30.

In the above-described first embodiment, the torsional rigidity of the torsion member 36 is relatively small and so the fluctuation torque absorbing ability of the torsion member is sensitive. Because the rotational torque T_{H} is arranged between the rotational torque 0 and T1, that is the same range of operation as the torsion member 36, the torsion member 36 absorbs an operation-related fluctuation torque of the generator 70. Therefore, when the rotational torque of the internal combustion engine 10 is between 0 and T1, the torque fluctuation absorber 30 inhibits or prevents the fluctuation torque of the internal combustion engine 10 from being transmitted to the generator 70 completely.

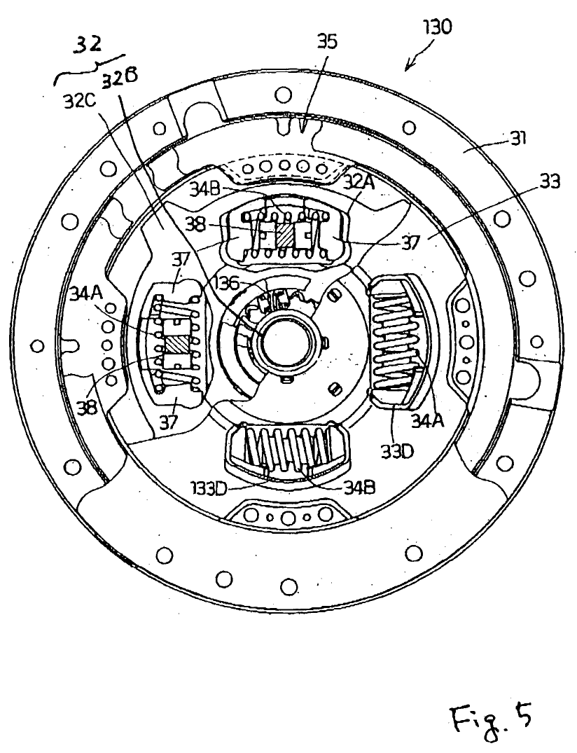

FIG. 5 illustrates the second embodiment of the torque fluctuation absorber in accordance with the present invention. In the second embodiment, parts that are the same as or similar to those described above in connection with the first embodiment are designated with the same reference numeral, and a detailed description of these features will not be repeated. Instead, the following description highlights differences between the second embodiment and the first embodiment.

One difference between the torque fluctuation absorber 130 shown in FIG. 5 and the earlier described embodiment involves the length of the torsion member 34. Although the torque fluctuation absorber 30 of the first embodiment has the four torsion members 34, each of which is formed by the same type of spring of the same length, the torque fluctuation absorber 130 of the second embodiment has two kinds of torsion member 34A, 34B. That is, the torque fluctuation absorber 130 has two torsion members 34A and two torsion members 34B. The length of the torsion member 34A is longer than that of the torsion member 34B. However, the lengths of the holes 32A for accommodating the torsion members 34A, 34B are the same. Thus, when the second rotational member 32 does not receive any rotational torque, a clearance between the ends of the torsion members 34B and the hole 32A exists. On the other hand, the intermediate member 33 has two holes 33D for accommodating one kind of the torsion members 34A and two holes 133D for accommodating the other torsion members 34B. The length of the holes 33D is longer than that of the holes 133D so that the holes 133D support the torsion member 34B without any clearance. Here, the torsional rigidity of the torsional member 34A is smaller than that of the torsional member 34B. Further, a torsion member 136 is located between the hub portion 32B and flange portion 32C.

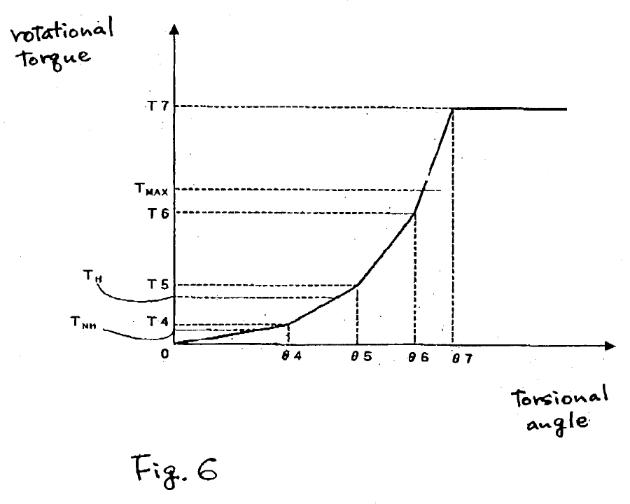

The operation of the above described second embodiment of the torque fluctuation absorber 130 is as follows. The graph in FIG. 6 illustrates the torsional characteristics of the torque fluctuation absorber 130, with the vertical axis representing the rotational torque from internal combustion engine 10 to the torque fluctuation absorber 30, and the horizontal axis representing the torsional angle between the first rotational member 31 and the second rotational member 32.

When the rotational torque is between 0 and T4, the transmitted torque is transmitted to the intermediate member 33 via the limiter 35 so that the intermediate member 33 rotates. Then, the rotational torque of the intermediate member 33 is transmitted to the flange portion 32C of the second rotational member 32 via the torsion member 34A. At that time, because the transmitted torque is comparatively small, the torsion member 34A transmits the rotational torque without contracting. Further, the rotational torque is transmitted to the hub portion 32B while contracting the torsion member 136. When the rotational torque reaches T4 (when the torsional angle becomes θ4), the gap in the circumferential direction between the hub portion 32B and the flange portion 32C is filled up so that the torsion member 136 cannot contract any more.

In the above described embodiment, the torsional rigidity of the torsion member 136 is established so that the transmitted torque T4 is larger than a rotational torque T_{NH}. The level of the rotational torque T_{NH} is the rotational torque of the internal combustion engine 10 when the internal combustion engine 10 does not operate the generator 70. Therefore, when the generator 70 is not operating, the torsion member 136 absorbs the torque fluctuation of the internal combustion engine 10.

When the rotational torque of the internal combustion engine 10 is between T4 and T5, the rotational torque is transmitted to the hub portion 32B as the torsion member 34A is contracted. At that time, the torsion member 136 is at its maximum contraction. Because the torsional rigidity of the torsion member 34A is stronger than that of the torsion member 136, the ratio of the rotational torque to the torsional angle in this condition when the rotational torque is between T4 and T5 is larger than that of the above described condition in which the rotational torque is between 0 and T4. When the rotational torque reaches T5 (when the torsional angle becomes θ5), the torsion member 34A becomes shortened so that the spring sheets 37 for supporting the torsion member 34B contact the respective hole 32.

The rotational torque T5, which can be absorbed by the torsion members 34A, is larger than a rotational torque T_{H}. The internal combustion engine 10 needs the level of the rotational torque T_{H}, when the internal combustion engine 10 operates the generator 70. Therefore, when the generator 70 is operated, the torsion members 34A absorb the torque fluctuation of the internal combustion engine 10.

When the rotational torque of the internal combustion engine 10 is between T5 and T6, the rotational torque is transmitted to the hub portion 32B as both of the torsion members 34A, 34B are contracted. At that time, the torsion member 136 is at its maximum contraction. Because the torsion members 34A, 34B are arranged in parallel to each other, a total torsional rigidity of the torsion members 34A, 34B becomes strong. Thus, the ratio of the rotational torque to the torsional angle in this condition in which the rotational torque is between T5 and T6, is larger than that of the above condition when the rotational torque is between T4 and T5. When the rotational torque reaches T6 (when the torsional angle becomes θ6), the torsion members 34A, 34B become shortened so that both of the spring sheets 37 contact the ends of the respective rubber damper 38.

When the rotational torque of the internal combustion engine 10 is between T6 and T7, the rotational torque is transmitted to the hub portion 32B as both of the torsion members 34A, 34B, and the rubber damper 38 are further contracted. Because the torsional rigidity of the rubber damper 38 is stronger than that of the torsion members 34A, 34B, the ratio of the rotational torque to the torsional angle in this condition when the rotational torque is between T6 and T7, is larger than that of the above condition when rotational torque is between T5 and T6. When the rotational torque reaches T7 (when the torsional angle becomes θ7), the frictional material 35A of the limiter 35 starts to glide. Thus, the limiter 35 transmits rotational torque from the intermediate member 33 to the second rotational member 32 that is no greater than the rotational torque T7. Here, because the rotational torque T7 is larger than the rotational torque T_{MAX}, it is not likely to happen that the frictional material 35A glides during the operation of the torque fluctuation absorber 130.

In the above-described second embodiment, because the rotational torque T_{NH} is arranged between the rotational torque 0 and T4, that is the same range of operation of the torsion member 136, and the rotational torque T_{H} is arranged between the rotational torque T4 and T5, that is the same range of operation of the torsion member 34A, either the torsion member 136 or the torsion member 34A absorbs operation-related fluctuation torque of the generator 70. Therefore, even if the difference between the rotational torque T_{NH} and the rotational torque T_{NH} is large, the torque fluctuation absorber is able to inhibit or prevent the fluctuating torque of the internal combustion engine 10 from being transmitted to the generator 70.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A torque fluctuation absorber for a hybrid vehicle comprising:
a first rotational member connected with an internal combustion engine,
a second rotational member connected with a generator,
a first torsion member located between the first rotational member and the second rotational member;
the first torsion member having torsional rigidity established to absorb an operation-related fluctuation torque of the generator;
a second torsion member located between the first rotational member and the second rotational member; and
the second torsion member having a torsional rigidity larger than that of the first torsion member.

2. The torque fluctuation absorber for a hybrid vehicle according to claim 1, wherein the operation-related fluctuation torque is a fluctuation torque upon starting the generator.

3. The torque fluctuation absorber for a hybrid vehicle according to claim 2, wherein the operation-related fluctuation torque includes a maximum rotational torque of the internal combustion engine that is necessary to operate the generator.

4. The torque fluctuation absorber for a hybrid vehicle according to claim 1, including a third rotational member positioned between the first and second rotational members, the third rotational member being rotatable relative to the first and second rotational members.

5. The torque fluctuation absorber for a hybrid vehicle according to claim 1, wherein the second rotational member is comprised of a hub portion and a flange portion, with a circumferentially extending clearance between the hub portion and the flange portion.

6. The torque fluctuation absorber for a hybrid vehicle according to claim 1, wherein the third rotational member is comprised of a three plates, and including a hysteresis mechanism at an inner circumferential portion of one of the three plates.

7. The torque fluctuation absorber for a hybrid vehicle according to claim 1, wherein the second torsion member is located in holes provided in the second rotational member.

8. The torque fluctuation absorber for a hybrid vehicle according to claim 7, including a third rotational member positioned between the first and second rotational members, the second torsion member being located in a hole in the third rotational member.

9. A torque fluctuation absorber for a hybrid vehicle comprising:
a first rotational member connected with an internal combustion engine;
a second rotational member connected with a generator;
a first torsion member located between the first rotational member and the second rotational member;
the first torsion member having a torsional rigidity adapted to absorb an operation-related fluctuation torque of the generator at a minimum necessary rotational torque for operating the generator during contraction of the first torsion member;
a second torsion member located between the first rotational member and the second rotational member;
the second torsion member having a torsional rigidity adapted to absorb an operation-related fluctuation torque of the generator at a maximum necessary rotational torque for operating the generator during contraction of the second torsion member;
a third torsion member located between the first rotational member and the second rotational member; and
the third torsion member having a torsional rigidity larger than that of the second torsion member during contraction of the third torsion member.

10. The torque fluctuation absorber for a hybrid vehicle according to claim 9, including a third rotational member positioned between the first and second rotational members, the third rotational member being rotatable relative to the first and second rotational members.

11. The torque fluctuation absorber for a hybrid vehicle according to claim 9, wherein the third torsion member is located inside second torsion member.

12. The torque fluctuation absorber for a hybrid vehicle according to claim 9, wherein the second rotational member is comprised of a hub portion and a flange portion, with a circumferentially extending clearance between the hub portion and the flange portion.

13. The torque fluctuation absorber for a hybrid vehicle according to claim 9, wherein the third rotational member is comprised of a three plates, and including a hysteresis mechanism at an inner circumferential portion of one of the three plates.

14. The torque fluctuation absorber for a hybrid vehicle according to claim 9, wherein the second and third torsion members are located in respective holes provided in the second rotational member.

15. The torque fluctuation absorber for a hybrid vehicle according to claim 14, including a third rotational member positioned between the first and second rotational members, both the second and third torsion members being located in a hole in the third rotational member.
